(19) United States
(12) Patent Application Publication
(10) Pub. No.: US 2019/0219517 A1
(43) Pub. Date: Jul. 18, 2019

(54) INSPECTION DEVICE

(71) Applicant: DENSO CORPORATION, Kariya-city (JP)

(72) Inventors: Masaru HORIGUCHI, Kariya-city (JP); Hiroyuki IWATSUKI, Kariya-city (JP); Kohei NAKAMURA, Kariya-city (JP); Katsuhiro MIYAGAKI, Kariya-city (JP); Shinji KATO, Kariya-city (JP)

(21) Appl. No.: 16/362,775

(22) Filed: Mar. 25, 2019

Related U.S. Application Data
(63) Continuation of application No. PCT/JP2017/034892, filed on Sep. 27, 2017.

(30) Foreign Application Priority Data
Sep. 28, 2016 (JP) 2016-190098

(51) Int. Cl. G01N 21/88; G06Q 10/06

(52) U.S. Cl. CPC G01N 21/8851; G06Q 10/06395

(57) ABSTRACT

An inspection device includes an irregular work detection unit that detects a worker carrying out irregular work different from standard work of an inspection, and a camera control unit that controls a wearable camera worn by the worker to take an image when irregular work is detected by the irregular work detection unit.

### CROSS REFERENCE TO RELATED APPLICATIONS

The present application is a continuation application of International Patent Application No. PCT/JP2017/034892 filed on Sep. 27, 2017, which designated the United States and claims the benefit of priority from Japanese Patent Application No. 2016-190098 filed on Sep. 28, 2016. The entire disclosures of the above applications are incorporated herein by reference.

### TECHNICAL FIELD

The present disclosure relates to an inspection device.

### BACKGROUND

In the manufacturing process of a product, the quality of an object to be inspected such as a product at an intermediate stage (hereinafter referred to as “workpiece”) or a finished product may be visually inspected by a worker. In this case, a wearable camera may support the inspection work by capturing images.

### SUMMARY

According to one aspect of the present disclosure, an inspection device is used for inspection of an inspection object by a worker, and may include an irregular work detection unit that detects the worker carrying out irregular work different from standard work of the inspection, and a camera control unit that controls a wearable camera worn by the worker to take an image when irregular work is detected by the irregular work detection unit.

### BRIEF DESCRIPTION OF DRAWINGS

FIG. 1 is a diagram schematically showing a schematic configuration of an inspection device according to a first embodiment and an example of an inspection work to which an inspection device is applied.

FIG. 2 is a block diagram showing a configuration of an inspection device according to the first embodiment.

FIG. 3 is a diagram showing functions relating to automatic recording during irregular work among the inspection device according to the first embodiment.

FIG. 4 is a diagram schematically showing an example of irregular work.

FIG. 5 is a flowchart of automatic recording processing during irregular work.

FIG. 6 is a diagram showing functions relating to automatic recording during irregular work among the inspection device according to a second embodiment.

FIG. 7 is a diagram showing functions relating to automatic recording during irregular work among the inspection device according to a third embodiment.

FIG. 8 is a diagram showing functions relating to automatic recording during irregular work among the inspection device according to a fourth embodiment.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

### First Embodiment

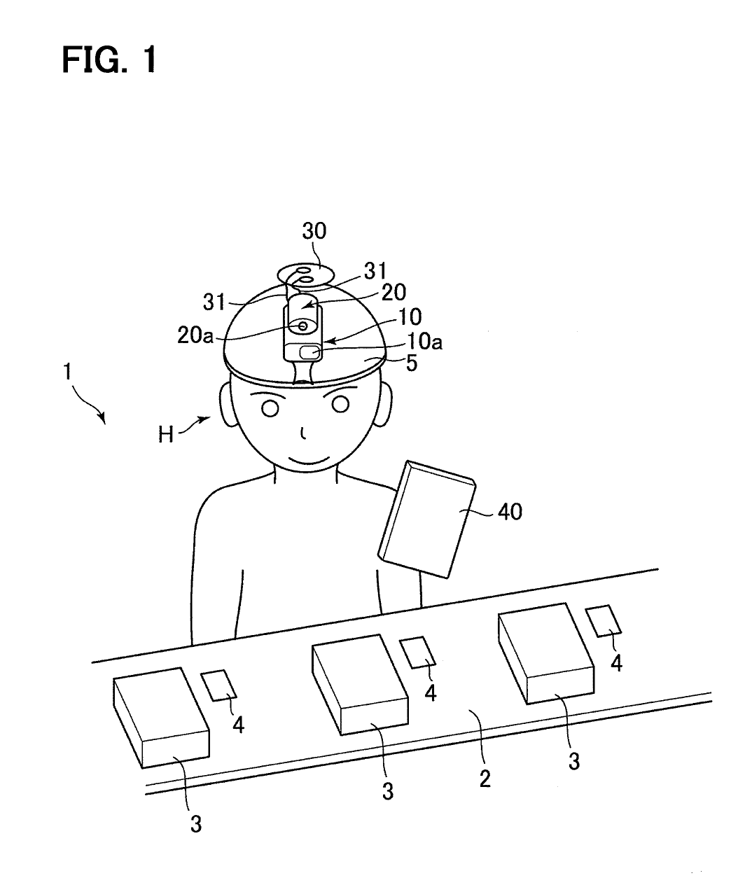

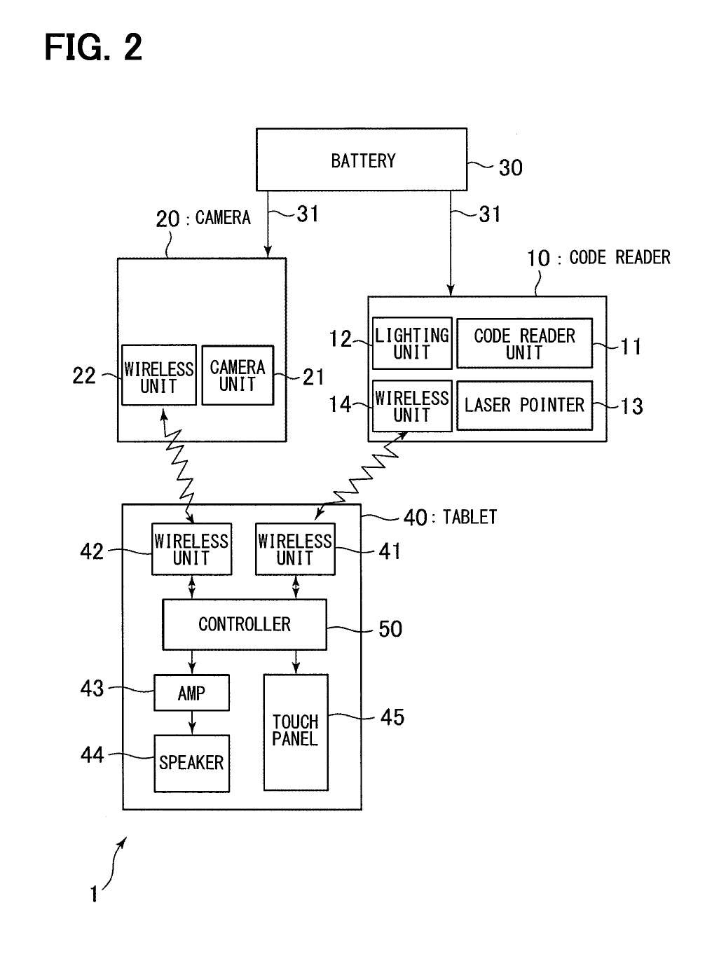

A first embodiment will be described hereafter with reference to FIGS. 1 to 5. First, with reference to FIG. 1 and FIG. 2, an example of an inspection work to which an inspection device 1 according to the first embodiment is applied and a schematic configuration of the inspection device 1 will be described.

The inspection device 1 according to the first embodiment is used in the manufacturing process of a product such as a heat exchanger. Specifically, the inspection device 1 is used in an inspection work for judging whether or not an object to be inspected, such as the workpiece 3 at an intermediate manufacturing stage or a finished product, are good products. As an example such inspection work, for example, the configuration shown in FIG. 1 is provided.

A worker H of the inspection work inspects whether or not the workpieces 3 sequentially conveyed by a conveyor 2 are good. The conveyor 2 carries a plurality of sets of workpieces 3 and signboards 4 and conveys these sets so that each set is positioned in front of the worker H in sequence. The signboard 4 is arranged near its corresponding workpiece 3, and a code indicating the type of the workpiece 3 is displayed on that signboard 4.

The worker H can perform the above-described inspection work using the inspection device 1 of the present embodiment. As shown in FIGS. 1 and 2, the inspection device 1 includes a code reader 10, a wearable camera 20, a battery 30, and a tablet 40.

As shown in FIG. 2, the code reader 10 includes a code reader unit 11, a lighting unit 12, a laser pointer unit 13, and a wireless unit 14.

The code reader unit 11 a well known optical code reader including a light source that irradiates light. Light is emitted from the light source through lens 10a, reflected by the signboard 4, and received through the lens 10a. The code reader unit 11 reads this reflected light to read codes. Here, the signboard 4 of the present embodiment is a display board on which a code is displayed. The code is an identification indicator indicating the type of the workpiece 3. Various codes, such as a QR code (registered trademark) or a bar code, may be used as the code.

The lighting unit 12 illuminates the workpiece 3 and its surroundings through the lens 10a.

The laser pointer unit 13 irradiates a laser beam as a pointer through the lens 10a. Thus, the laser pointer unit 13 assists the worker H to recognize a target reading area in which the code reader unit 11 reads codes. In the present embodiment, the region irradiated with the laser beam by the laser pointer unit 13 is set to coincide with the target reading area of the code reader unit 11.

The wireless unit 14 is composed of an antenna, a wireless circuit, and the like, and wirelessly communicates with the wireless unit 41 of the tablet 40.

The wearable camera 20 is a compact camera which is attached to a body or the like and is intended to capture images in a hands-free manner. As shown in FIG. 2, the wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42 of the tablet 40.

The battery 30 is a secondary battery that supplies direct current power to the code reader 10 and the camera 20 via a harness 31 or the like.

In the present embodiment, as shown in FIG. 1, the code reader 10, the wearable camera 20, and the battery 30 are mounted on a hat 5 to be work by the worker H. Further, the code reader 10 and the wearable camera 20 are installed on the hat 5 of the worker H so that the lens 10a of the code reader 10 and the lens 20a of the wearable camera 20 are disposed facing the front of the worker H.

The tablet 40 is a portable terminal configured to be carried by the worker H. As shown in FIG. 2, the tablet 40 includes wireless units 41 and 42, an amplifier 43, a speaker 44, a touch panel 45, and a controller 50.

The wireless units 41 and 42 are composed of an antenna, a wireless circuit, and the like. The wireless unit 41 wirelessly communicates with the wireless unit 14 of the code reader 10. The wireless unit 42 wirelessly communicates with the wireless unit 22 of the wearable camera 20. In the present embodiment, various types of short range wireless communications may be used for wireless communication between the wireless units. Bluetooth (registered trademark) or Wi-Fi (registered trademark) can be used as the short-range wireless communication.

The amplifier 43 amplifies the voltage of the analog signal output from the controller 50 and outputs an amplified signal. The speaker 44 converts the amplified signal output from the amplifier 43 into sound and outputs the sound. The touch panel 45 is a display device combining a transparent key input operation unit and a display panel.

The controller 50 is a device that controls the operation of each part of the inspection device 1 related to the above-described inspection work. The controller 50 is physically a microcontroller composed of a CPU, a memory, digital-analog conversion circuits, and the like. The controller 50 executes an inspection process in accordance with a computer program stored in advance in the memory. The inspection process is a determination process of determining whether or not the workpiece 3 is a non-defective product based on the code acquired from the code reader 10 and the captured image acquired by the wearable camera 20.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1 configured in this way, the standard work of the inspection process (hereinafter referred to as “standard work) of the workpiece 3 performed by the worker H may be, for example, performed as follows.

First, the worker H directs their head to face the signboard 4, so that the code reader 10 attached to the hat 5 reads the code from the signboard 4. Next, the head is directed to face the workpiece 3, and the wearable camera 20 attached to the hat 5 likewise captures the image of the workpiece 3 to acquire the captured image. That is, with the code reader 10 reading the code from the signboard 4 as the trigger, the wearable camera 20 acquires the captured image of the workpiece 3. The tablet 40 receives the code from the code reader 10 via wireless communication and receives the captured image from the wearable camera 20.

The controller 50 in the tablet 40 selects the reference image corresponding to the received code from the plurality of types of reference images stored in advance in the memory as described above. The controller 50 compares the captured image of the workpiece 3 with the reference image to determine whether or not the workpiece 3 is a non-defective product. In addition, the controller 50 notifies the worker H of the result of pass/fail judgment of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1 configured as described above is carried by the worker H as a wearable device so that both hands of the worker H are free. With the above configuration, the inspection device 1 can automatically perform the inspection work of the inspection object without requiring the operation using the both hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

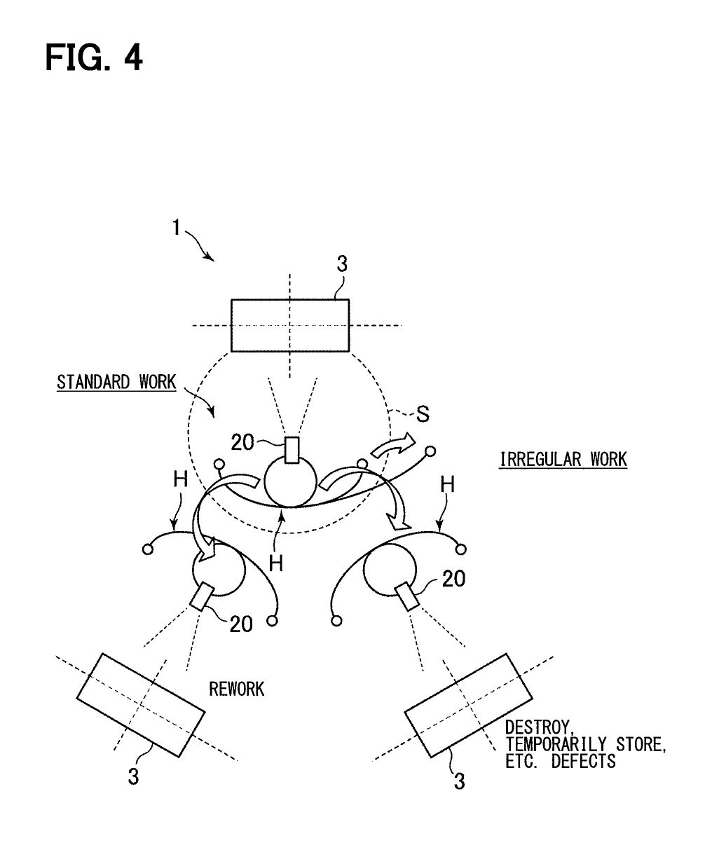

It should be noted that, in the course of the above-described inspection work, there are cases where the worker H does not only perform the above-mentioned standard work but also performs various exceptional work (hereinafter referred to as “irregular work”) different from the standard work. For example, as shown in FIG. 4, when the inspection device 1 determines that the workpiece 3 is a defective product, the worker H may be required to perform irregular work such that carrying the workpiece 3 to another work space and reworking the workpiece 3, or discarding the defective workpiece 3, or temporarily placing the defective workpiece 3 in another area.

With respect to such irregular work, it is preferable to be able to automatically record using the wearable camera 20 of the inspection device 1 for the purpose of, for example, checking whether or not the irregular work itself has occurred or checking the contents of that irregular work at a later time. However, as described above, while standard work is in progress, the wearable camera 20 is able to capture images with the trigger being the code reader 10 reading a code from the signboard 4. Whereas for irregular work, since there is no trigger similar to the standard work. Accordingly, it is necessary to separately provide a start trigger for irregular work.

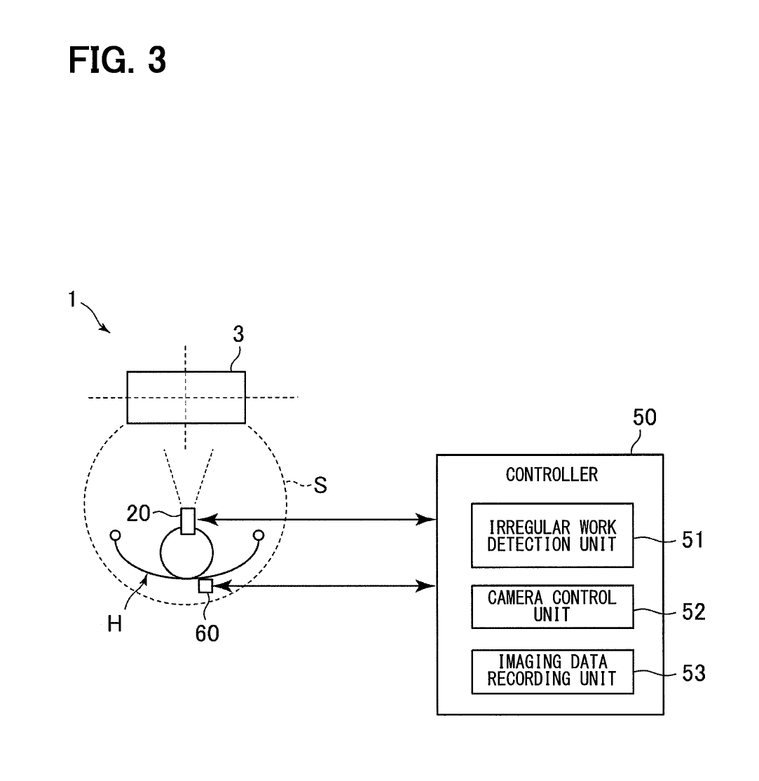

Therefore, in the present embodiment, attention has been paid to a specific standard work region S in which the worker H exists during standard work. As shown in FIGS. 3 and 4, for example, the standard work region S can be defined as a region of space where the worker H can visually recognize the workpiece 3 in front of the worker H, and the hands of the worker H are able to reach the workpiece 3. Then, when the worker H carries out irregular work, as shown in FIG. 4, it is considered that the worker H will transition to a state in which the worker H is not contained within the standard work region S. For example, the entire body of the worker H may leave the standard work region S, or a part of the body of the worker H, such as a hand or an arm, may leave the standard work region S. Therefore, in the present embodiment, irregular work is determined on the condition that a part or all of the body of the worker H has exited the standard work region S.

As shown in FIG. 3, as functions relating to automatic recording during such irregular work, the controller 50 of the inspection device 1 includes an irregular work detection unit 51, a camera control unit 52, an imaging data recording unit 53. Further, the inspection device 1 has a gyro sensor 60 mounted on the worker H as an element for detecting an irregular region.

The irregular work detection unit 51 detects when the worker H is carrying out irregular work. In the first embodiment, information from the gyro sensor 60 attached to the worker H is utilized to detect the occurrence of irregular work.

The camera control unit 52 controls the operation of the wearable camera 20. Here, when an irregular work is detected by the irregular work detection unit 51, the camera control unit 52 starts capturing images with the wearable camera 20.

The imaging data recording unit 53 records the imaging data of the irregular work captured by the wearable camera 20. The captured data can be in any form such as video data during irregular work or a set of still image data captured at predetermined intervals during irregular work.

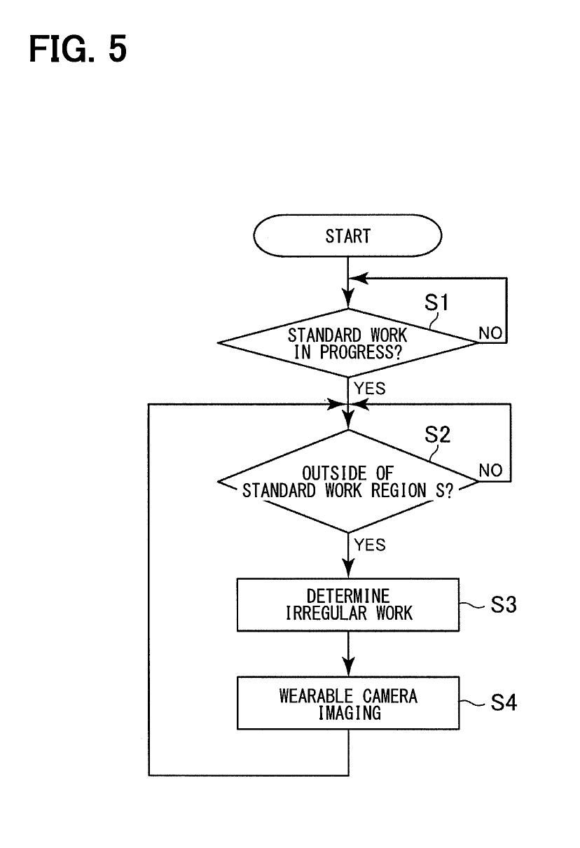

With reference to FIG. 5, the procedure of automatic recording processing during irregular work will be described. The processing of the flowchart shown in FIG. 5 is executed by the controller 50 of the inspection device 1 while standard work is in progress.

In step S1, it is determined whether the worker H is performing standard work. The controller 50 can determine that the worker H is performing standard work when there is an operation related to standard work, such as reception of code information from the code reader 10. As a result of the judgment in the step S1, if the worker H is in the middle of standard work (YES in the step S1), the process proceeds to the step S2. Otherwise (NO in the step S1) the process is on standby until the worker H begins standard work.

In step S2, the irregular work detection unit 51 determines whether or not the worker H is outside of the standard work region S. The irregular work detection unit 51 can determine whether or not the worker H is out of the standard work region S by using the information from the gyro sensor 60 attached to the worker H. The irregular work detection unit 51 estimates the direction in which the worker H is facing based on the information from the gyro sensor 60. When the estimated direction is different from the standard work, for example, when the estimated direction exceeds the allowable range of the direction in which the worker H can face during standard work, it is determined that the worker H has moved outside of the standard work region S. As a result of the determination in step S2, if the worker H is out of the standard work region S (YES in step S2), the process proceeds to step S3. Otherwise (NO in step S2), the determination process in step S2 is repeated until it is determined that the worker H is out of the standard work region S.

In step S3, since the worker H is determined to be outside of the standard work region S as a result of the determination in step S2 by the irregular work detection unit 51, it is then determined that the worker H is presently carrying out irregular work. The irregular work detection unit 51 outputs the determination result to the camera control unit 52. When the process of step S3 is completed, the process moves to step S4.

In step S4, in accordance with the determination of irregular work in step S3, the camera control unit 52 controls the wearable camera 20 to capture images. The camera control unit 52 records the imaging data of the irregular work captured by the wearable camera 20 in the imaging data recording unit 53. When the process of step S4 is completed, the process returns to step S2.

Next, effects of the inspection device 1 according to the first embodiment will be described. In the inspection device 1 of the first embodiment, when the irregular work detection unit 51 of the controller 50 detects the irregular work of the worker H, the camera control unit 52 controls the wearable camera 20 to capture images. In other words, since the detection of the irregular work is a trigger for capturing the imaging data of the irregular work by the wearable camera 20, it is possible to accurately capture the irregular work of the worker by the wearable camera.

In addition, in the inspection device 1 of the first embodiment, the irregular work detection unit 51 detects that a worker H is in the standard work region S when the worker is performing standard work of quality inspection of workpieces 3. Then, the irregular work detection unit 51 detects that the worker H is performing irregular work when the worker H leaves the standard work region S.

With this configuration, it is possible to clearly divide standard work and irregular work based on the criteria of whether the worker H is within or outside of the range of the standard work region S. Accordingly, irregular work can be accurately detected. By improving the detection accuracy of the irregular work, it is possible to accurately ascertain the opportunity to capture the irregular work of the worker H by the wearable camera 20.

Further, in the inspection device 1 of the first embodiment, the irregular work detection unit 51 calculates the direction in which the worker H faces based on the information from the gyro sensor 60 attached to the worker H. When the calculated direction is different from the direction of performing standard work, the worker H is determined to be outside of the standard work region S. With this configuration, it is possible to accurately detect that the worker H is outside of the standard work region S based on the direction in which the worker H is facing, so that the capturing of the images of the irregular work of the worker H by the wearable camera 20 can be done more appropriately.

Further, instead of the gyro sensor 60, another sensor related to an operation of the worker H having a significant difference between standard work and irregular work may be used. For example, an acceleration sensor may be used instead of the gyro sensor 60.

In the case of using the acceleration sensor, in step S2 of FIG. 5, the irregular work detecting unit 51 estimates a motion amount of the worker H based on the information from the acceleration sensor. The motion amount may be, for example, the amount of movement of the entire body of the worker H when the acceleration sensor is attached to the midsection of the worker H, or may be the amount of movement of the hand or arm of the worker H when the acceleration sensor is attached to the arm or hand of the worker H. Then, when this estimated motion amount exceeds the range of the standard work region S, for example when the estimated motion amount exceeds a predetermined threshold value corresponding to the size of the standard work region S, it is determined that the worker H has moved outside of the standard work region S. With this configuration as well, it is possible to accurately detect that the worker H is outside of the standard work region S based on the motion amount of a part or all of the body of the worker H, so that, in the same manner as when the gyro sensor 60 is used, the capturing of the images of the irregular work of the worker H by the wearable camera 20 can be done more appropriately.

Further, it is possible to use a configuration in which the irregular work detecting unit 51 combines information from the gyro sensor 60 and information of other sensors such as an acceleration sensor to determine whether or not the worker H is outside of the standard work region S.

### Second Embodiment

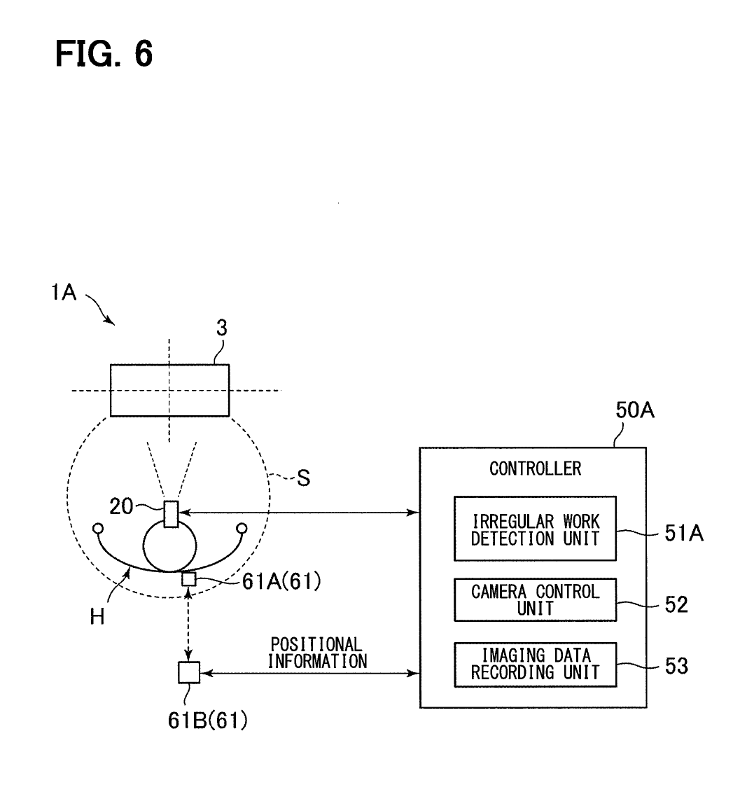

The second embodiment will be described with reference to FIG. 6. An inspection device 1A according to the second embodiment is different from the inspection device 1 according to the first embodiment with respect to the information used for determining that the worker H is outside of the standard work region S.

As shown in FIG. 6, in the inspection device 1A according to the second embodiment, the irregular work detection unit 51A of the controller 50A determines, based on the positional information of the worker H acquired from a positional information acquisition device 61, that the worker H is outside of the standard work region S. The positional information acquisition device 61 includes a transmitter 61A mounted on the worker H and a receiver 61B installed in the inspection work space. The positional information acquisition device 61 calculates the position coordinates of the worker H based on the reception state (for example, the reception intensity or the arrival time) of the signal transmitted from the transmitter 61A to the receiver 61B to detect whether the worker H is in the standard work region S. As the positional information acquisition device 61, for example, a technique using RFID can be used. In the case of the configuration of the second embodiment, in step S2 of FIG. 5, the above process of the irregular work detection unit 51A is used to determine whether or not the worker H is outside of the standard work region S.

With this configuration as well, it is possible to accurately detect that the worker H is outside of the standard work region S based on the positional information of the worker H so that, similar to the inspection device 1 of the first embodiment, the capturing of the images of the irregular work of the worker H by the wearable camera 20 can be done more appropriately with the inspection device 1A of the second embodiment as well.

### Third Embodiment

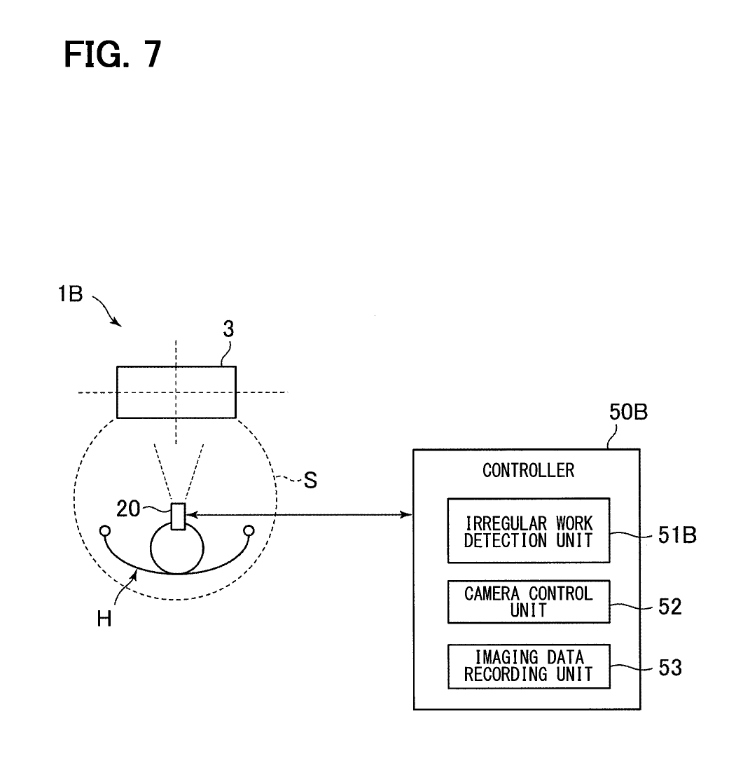

The third embodiment will be described with reference to FIG. 7. An inspection device 1B according to the third embodiment is different from the inspection device 1 according to the first embodiment with respect to the information used for determining that the worker H is outside of the standard work region S.

As shown in FIG. 7, in the inspection device 1B according to the third embodiment, the irregular work detection unit 51B of the controller 50B determines, based on images from the wearable camera 20, that the worker H is outside of the standard work region S when different from images of standard work. For example, the irregular work detection unit 51B may retain, as a template, a typical camera image obtained when the worker H is performing standard work in the standard work region S. Then, the camera images input from the wearable camera 20 during work are pattern matched with the template image to perform the determination. For example, when the matching degree of pattern matching is lower than a predetermined threshold value, it is determined that the worker H is in a viewing position different from the standard work and that the worker H is outside of the standard working region S. In the case of the configuration of the third embodiment, in step S2 of FIG. 5, the above process of the irregular work detection unit 51B is used to determine whether or not the worker H is outside of the standard work region S.

With this configuration as well, it is possible to accurately detect that the worker H is outside of the standard work region S based on the information related to the visual field of the worker H so that, similar to the inspection device 1 of the first embodiment, the capturing of the images of the irregular work of the worker H by the wearable camera 20 can be done more appropriately with the inspection device 1B of the third embodiment as well.

### Fourth Embodiment

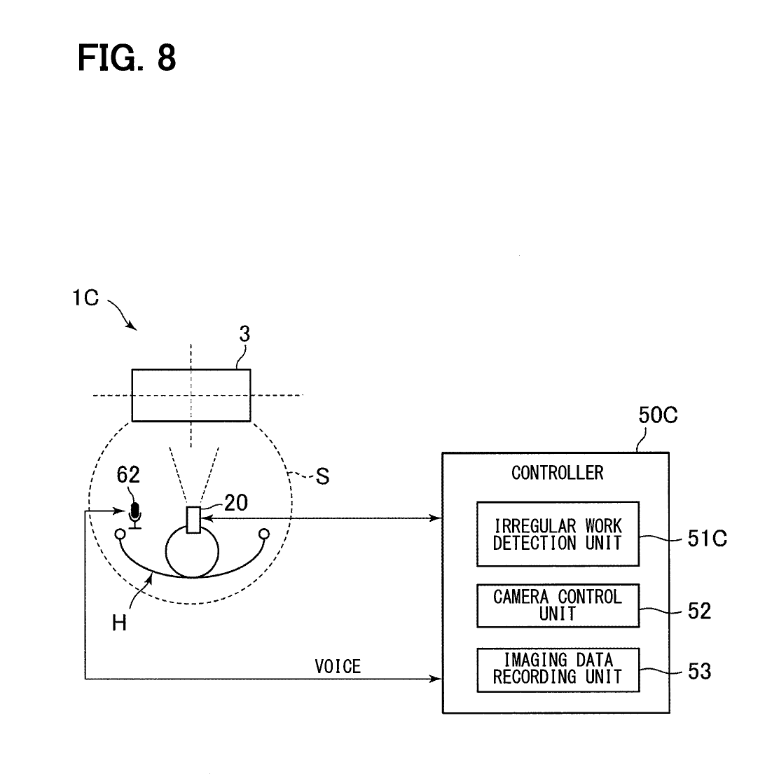

The fourth embodiment will be described with reference to FIG. 8. An inspection device 1C according to the fourth embodiment is different from the inspection device 1 according to the first embodiment with respect to the information used for determining that the worker H is outside of the standard work region S.

As shown in FIG. 8, in the inspection device 1C according to the fourth embodiment, the irregular work detection unit 51C of the controller 50C determines, based on a voice of the worker H, that the worker H is outside of the standard work region S. The inspection device 1 includes a microphone 62 that is attached to the worker H or installed near the worker H. When it becomes necessary for the worker H to leave the standard work region S for irregular work during standard work, the worker H speaks to the microphone 62 to convey that fact. The irregular work detection unit 51C acquires the voice information of the worker H via the microphone 62 and analyzes the voice information. Then, in the case where the content speech indicates that the worker H is exiting from the standard work region S or that irregular work is to be performed, it is determined that the worker H is outside of the standard work region S and is performing irregular work. In the case of the configuration of the fourth embodiment, in step S2 of FIG. 5, the above process of the irregular work detection unit 51C is used to determine whether or not the worker H is outside of the standard work region S.

With this configuration as well, it is possible to accurately detect that the worker H is outside of the standard work region S based on the voice information from the worker H so that, similar to the inspection device 1 of the first embodiment, the capturing of the images of the irregular work of the worker H by the wearable camera 20 can be done more appropriately with the inspection device 1C of the fourth embodiment as well.

The present embodiment has been described above with reference to the specific examples. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The elements included in each of the specific examples described above can be appropriately combined as long as there is no technical contradiction.

The details of the inspection work to which the inspection device 1, 1A, 1B, 1C according to the embodiments described with reference to FIG. 1 and FIG. 2 are applied and the specific configurations of the inspection device 1, 1A, 1B, 1C are merely examples and are not limited to those shown in FIGS. 1 and 2. For example, in the above described embodiments, the inspection object to be inspected for pass/fail determination is the workpiece 3 which is the product at an intermediate stage of production, but completed products can also be included.

In the above embodiments, the control devices 50, 50A, 50B, 50C (and the irregular work detection units 51, 51A, 51B, 51C, the camera control unit 52, and the imaging data recording unit 53 included therein) are mounted on the tablet 40 and are carried by the worker H of the inspection work. However, this is an exemplary embodiment, and at least a part of these constituent elements may be provided at another place apart from the work area of the worker H. As such a configuration, for example, a configuration in which these constituent elements are mounted in a computer apparatus installed at a remote location is contemplated.

In the above described embodiments, the wearable camera 20 is installed on the head of the worker H. However, the installation position of the wearable camera 20 is not limited to the head, but may be an arm portion, a hand portion, a midsection, or any other arbitrary part of the body of the worker H.

1. An inspection device used for inspection of an inspection object by a worker, comprising:
an irregular work detection unit that detects the worker carrying out irregular work different from standard work of the inspection, and
a camera control unit that controls a wearable camera worn by the worker to take an image when irregular work is detected by the irregular work detection unit.

2. The inspection device of claim 1, wherein the irregular work detection unit is configured to detect that the worker is performing the irregular work when the worker is outside of a standard work region, which is a region in which the worker exists while performing the standard work.

3. The inspection device of claim 2, wherein the irregular work detection unit calculates a direction in which the worker faces based on information from a gyro sensor attached to the worker, and when the calculated direction is different from a direction of performing the standard work, the worker is determined to be outside of the standard work region.

4. The inspection device of claim 2, wherein the irregular work detection unit calculates a movement amount of the worker based on information from an acceleration sensor attached to the worker, and when the calculated movement amount exceeds a range of the standard work region, the worker is determined to be outside of the standard work region.

5. The inspection device of claim 2, wherein the irregular work detection unit determines that the worker is outside of the standard work region based on positional information of the worker acquired from a positional information acquisition device that acquires the positional information of the worker

6. The inspection device of claim 2, wherein the irregular work detection unit determines that the worker is outside of the standard work region based on an image of the wearable camera being different from an image during the standard work.

7. The inspection device of claim 2, wherein the irregular work detection unit determines that the worker is outside of the standard work area based on a voice of the worker.

8. An inspection device used for inspection of an inspection object by a worker, comprising:
a camera configured to be attached to the worker; and
a processor coupled to the camera, the processor being programmed to:
detect the worker carrying out irregular work different from standard work of the inspection, and
upon detecting the irregular work, control the camera to take an image.
